(19) United States
(12) Patent Application Publication
(10) Pub. No.: US 2001/0018305 A1
(43) Pub. Date: Aug. 30, 2001

(54) Polyester fabric and process for the preparation thereof

(75) Inventors: Peter Habereder, Marktl (DE); Martina Obenhuber, Burghausen (DE); Claus Munique, Wiesbaden (DE)

Correspondence Address: William G. Conger, Brooks & Kushman P.C., Twenty-Second Floor, 1000 Town Center, Southfield, MI, 48075, US

(73) Assignee: Wacker-Chemie GmbH, Munchen (DE)

(21) Appl. No.: 09/778,196

(22) Filed: Feb. 6, 2001

(30) Foreign Application Priority Data
Feb. 10, 2000 (DE) 100 05 855.8

(51) Int. Cl. B32B 5/02

(52) U.S. Cl. 442/102

(57) ABSTRACT

A treated polyester fabric comprises a polyester textile and at least one organopolysiloxane and at least one alkylpolyglycoside. The organopolysiloxane and alkylpolyglycoside are added to the textile material, which may be woven or non-woven and may additionally contain other textile fibers, in the form of an aqueous emulsion. The treated fabrics display increased washfastness.

### BACKGROUND OF THE INVENTION

1. Field of the Invention

The present invention pertains to polyester fabrics, and in particular to fabrics containing, in addition to a polyester textile substrate, an organopolysiloxane and an alkylpolyglycoside. The present invention further pertains to a process for softening a polyester textile product by contacting the textile with an aqueous emulsion of organopolysiloxane and alkylpolyglycoside.

2. Background Art

It is known to finish textile fabrics such as wovens, knits or nonwovens with silicone softeners to create a pleasant, soft hand. Amino-functional silicones provide an unsurpassed soft hand, and are commercially available in the form of micro- or macroemulsions. These amino-functional softeners, however, have serious disadvantages when used for finishing polyester fabrics. A particularly critical drawback is the deterioration in the washfastnesses of dyeings and prints.

### SUMMARY OF THE INVENTION

It is an object of the present invention to overcome the disadvantages of the prior art, and to thereby provide treated polyester fabrics with a soft hand which retain washfastness. These and other objects are achieved by the invention, wherein a softening composition comprising an organopolysiloxane and an alkylpolyglycoside are employed as a “softening agent composition”. The invention accordingly provides a polyester fabric comprising at least one organopolysiloxane and at least one alkylpolyglycoside.

### DETAILED DESCRIPTION OF THE PREFERRED EMBODIMENT(S)

It has now been surprisingly discovered that the disadvantages attributed to use of amino-functional siloxanes with polyester fabrics do not occur when the softener silicone fraction comprises known aminosilicones, but which, according to the invention, are applied in the form of aqueous emulsions employing alkylpolyglycosides as emulsifiers. Other silicones may be used with these emulsifiers as well. “Polyester fabrics” may comprise polyester alone, or blends of polyester with cotton, wool or other materials, and may be wovens, knits or nonwovens useful for garments, tablecloths, covers, tents, transit containers such as bag and rucksacks, etc. Polyester fabrics are customarily dyed or printed with disperse dyes and generally undergo dye fixation by treatment under pressure at 130° C. The term “polyester textile” is used herein to specify an untreated substrate.

The organopolysiloxanes (a) which can be employed are preferably organopolysiloxanes which have polar groups on Si-C-bonded hydrocarbyl radicals, preferably polar groups such as amino, ammonium, epoxy, hydroxyl, amido, mercapto, carboxyl and/or sulfonic acid groups, their salts or esters. These polar organopolysiloxanes may be used in the form of mixtures containing more than one polar organopolysiloxane, and may be admixed with non-polar organopolysiloxanes as well.

The organopolysiloxanes (a) preferably have the general formula (I)

RₙR′ₘSiO_{(4-n-m)/2} (I)

where

R preferably denotes identical or different, substituted or unsubstituted hydrocarbyl radicals or hydrocarbyloxy radicals having, in each case, 1 to 18 carbon atoms, or hydrogen atoms or hydroxyl radicals,

R′ preferably denotes identical or different Si-C-bonded hydrocarbyl radicals containing polar groups as substituent(s),

n is an integer having a value of 0, 1, 2 or 3,

m is an integer having a value of 0, 1, 2 or 3,

the sum (n+m) has an average value of 1.8 to 2.2, and m is such that the polyorganosiloxane has at least one R′ radical. The sum (n+m) preferably has an average value of 1.9 to 2.1.

Examples of hydrocarbyl radicals R are alkyl radicals such as methyl, ethyl, n-propyl, isopropyl, n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical, and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; alkenyl radicals such as the vinyl, allyl and 5-hexen-1-yl radicals; cycloalkyl radicals such as the cyclopentyl, cyclohexyl, cycloheptyl and methylcyclohexyl radicals; aryl radicals such as the phenyl, naphthyl, anthryl, and phenanthryl radicals; alkaryl radicals such as o-, m-, p-tolyl radicals, xylyl and ethylphenyl radicals; and aralkyl radicals such as the benzyl, α-phenylethyl, and β-phenylethyl radicals.

Examples of substituted or unsubstituted hydrocarbyloxy R are substituted or unsubstituted hydrocarbyl radicals R attached via an oxygen atom directly to a silicon atom, preferably alkoxy radicals of 1 to 18 carbon atoms and phenoxy radicals, more preferably methoxy, ethoxy, n-propoxy, isopropoxy and phenoxy radicals. Preferably not more than 5% of the R radicals are substituted or unsubstituted hydrocarbyloxy radicals.

Examples of the preferred amino-functional R′ radicals are radicals of the general formula (II)

—R¹—[NR²(CH₂)ₐ]_{b}NHR² (II)

and their ammonium salts preparable by reaction with mineral or carboxylic acids, where

R¹ is preferably a divalent C₁- to C₁₈-hydrocarbyl radical,

R² is preferably a hydrogen atom or an optionally fluorine-, chlorine- or bromine-substituted C₁- to C₁₈-hydrocarbyl radical,

a is a positive integer, preferably 2, 3, 4, 5 or 6, and

b is a non-negative integer, preferably 0, 1, 2, 3 or 4.

Examples of divalent C₁- to C₁₈-hydrocarbyl R¹ are preferably saturated, straight- chain, branched-chain, or cyclic alkylene radicals such as methylene, ethylene, propylene, butylene, pentylene, hexylene, 2-methylpropylene, cyclohexylene and octadecylene radicals, or unsaturated alkylene or arylene radicals such as hexenylene and phenylene radicals, among which n-propylene and 2-methylpropylene are particularly preferred.

Examples of hydrocarbyl R² are preferably the examples specified for R. Examples of halogen-substituted hydrocarbyl R² are haloalkyl radicals, such as 3,3,3-trifluoro-n-propyl, 2,2,2,2′,2′,2′-hexafluoroisopropyl, heptafluoroisopropyl and haloaryl radicals, such as o-, m- and p-chlorophenyl.

In the foregoing general formula (II), preferably

R¹ is a divalent C₂- to C₆-hydrocarbyl radical,

R² is a hydrogen atom, a methyl or cyclohexyl radical,

a is 2 or 3 and

b is 0 or 1.

Particular preference is given to linear polydimethylsiloxanes which optionally include as R radicals methyl radicals and not more than 5% of C₁- to C₃-alkoxy or hydroxy end groups. In these polydimethylsiloxanes the R′ radicals are preferably

H₂N(CH₂)₂NH(CH₂)₃-, H₂N(CH₂)₂NHCH₂CH(CH₃)CH₂-,

H₂N(CH₂)₃-,

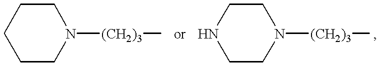

Examples of mineral acids which can be reacted with the aforementioned amino-functional hydrocarbyl radicals to form the corresponding ammonium-functional radicals are preferably hydrochloric, perchloric, sulfuric, sulfurous, nitric, nitrous, hydrofluoric, phosphoric, diphosphoric and polyphosphoric acids. Examples of suitable carboxylic acids are preferably alkanoic acids such as formic, acetic, propionic, and butanoic acids, citric acid, trichloro-, dichloro- and chloroacetic acid, trifluoroacetic acid, cyanoacetic acid, phenylacetic acid, benzoic acid, m- and p-nitrobenzoic acid, oxalic acid, malonic acid and lactic acid. Particular preference is given to the ammonium-functional hydrocarbyl radicals obtainable with acetic acid.

Examples of preferred amino-functional radicals are γ-acetamidopropyl radicals, and partially or completely acetylated β-aminoethyl-γ-aminopropyl radicals.

Examples of epoxy-functional R′ radicals are radicals of the general formulae (III) and (IV)

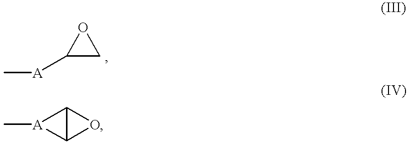

where A is an alkyl, alkoxyalkyl, aryl or alkaryl radical.

Examples of preferred epoxy-functional R′ radicals are

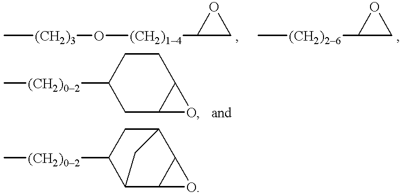

Particularly preferred epoxy-functional R′ radicals are

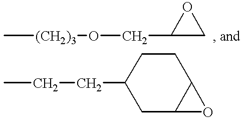

The preferred epoxide numbers for the epoxy-functional organopolysiloxanes (a) are 0.5 to 0.001 (equiv./100 g), especially 0.2 to 0.01 (equiv./100 g). The epoxide number of an epoxy-functional organopolysiloxane indicates the number of equivalents of epoxide, namely the number of moles of epoxide groups, contained in 100 grams of organopolysiloxane (a).

Examples of preferred carboxyl-functional R′ radicals are radicals of the general formula (V)

—X—(COOH)ₚ (V)

and their salts preparable by reaction with bases, where

X is a linear, branched aliphatic, aromatic or mixed aliphatic and aromatic hydrocarbyl radical whose carbon structure may be interrupted by divalent sulfur, oxygen or carboxylic ester radicals and

p is 1 or 2.

Particularly preferred carboxyl-functional R′ radicals are the radicals

—(CH₂)₄₋₁₀—COOH,

—CH₂CH(CH₃)—COOH,

—(phenyl)—COOH,

—CH₂CHR³—S—CH₂—COOH,

where R³ is preferably a hydrogen atom, a methyl or ethyl radical,

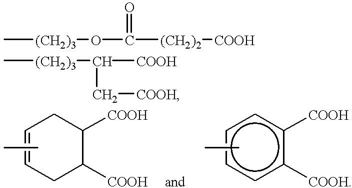

Particular preference as carboxyl-functional R′ radicals is given to the radicals

—(CH₂)₁₀—COOH,

—CH₂CH(CH₃)—COOH and

—(CH₂)₂—S—CH₂—COOH.

Examples of bases for reaction with carboxyl-functional organopolysiloxanes (a) comprising R′ radicals are preferably ammonia, amines, and alkali metal and alkaline earth metal hydroxides such as LiOH, NaOH, KOH, RbOH, CsOH, Mg(OH)₂, Ca(OH)₂, Sr(OH)₂ and Ba(OH)₂

The preferred acid numbers for the carboxyl-functional organopolysiloxanes (a) are 1 to 100 (mg KOH/g), preferably 5 to 50 (mg KOH/g) and especially 10 to 30 (mg KOH/g). The acid number of a carboxyl-functional organopolysiloxane (a) indicates the number of milligrams of potassium hydroxide needed to neutralize the free acids contained in one gram of the carboxyl-functional organopolysiloxane (a).

R is preferably methyl, ethyl, phenyl, methoxy and/or vinyl. Preferably 50% of the R radicals, more preferably at least 80% of the R radicals are methyl radicals, as organopolysiloxaens are easier to obtain. It is possible to use one organopolysiloxane (a), preferably an organopolysiloxane (a) of the formula (I); it is also possible to use a plurality of organopolysiloxanes. The organopolysiloxane (mixture) used in the emulsions is preferably a liquid. More particularly, the organopolysiloxanes used in the process of the invention preferably each have viscosities of 100 mPa.s to 1,000,000 mPa.s, measured at 25° C.

When an amino-functional organopolysiloxane is used for preparing the ammonium-functional organopolysiloxane (a) preferably used in the emulsions of the invention, it is preferable for it to have an amine number of 0.1 to 3.0, especially 0.2 to 0.9. The amine number of an amino-functional substance is defined as ml of 1N hydrochloric acid consumed in the titration of 1 g of the amino-functional substance.

Useful alkylpolyglycosides include for example the alkylpolyglycosides, disclosed in EP-A 418 479 alkylpolyglycosides of the general formula (VI)

R″—O—Zₒ (VI)

where

R″ is a linear or branched, saturated or unsaturated alkyl radical having on average 8 to 24 carbon atoms, preferably 8 to 16 carbon atoms, and

Zₒ is preferably an oligoglycoside radical having on average o=1 to 10, preferably 1 to 5, hexose or pentose units or mixtures thereof.

Particular preference is given to alkylpolyglycosides having a saturated alkyl radical with on average 8 to 14 carbon atoms and an average degree of glycosidation, n, between 1.1 and 3.

The invention further provides a process for treating a polyester fabric, which comprises applying at least one organopolysiloxane and at least one alkylpolyglycoside. The process preferably comprises treatment of the polyester fabric with an aqueous emulsion comprising, preferably

a) 100 parts by weight of organopolysiloxanes which preferably have polar groups on Si-C-attached hydrocarbyl radicals and

b) up to 150 parts by weight of alkylpolyglycosides, wherein the organopolysiloxanes and alkylpolyglycosides have the above-indicated meanings.

In contrast to the aqueous emulsions of polydimethylsiloxane oils and polydiphenylsiloxane oils with alkylpolyglycoside emulsifiers, the emulsions used according to the invention have a higher stability to extraneous electrolytes, such as magnesium and sodium salts, than corresponding emulsions where alkylpolyglycol ethers are used as emulsifiers.

The emulsions employed the subject invention contain relatively small amounts of emulsifiers, especially 5 to 100 parts by weight of alkylpolyglycosides (b) per 100 parts by weight of organopolysiloxanes (a) containing polar groups.

The emulsions have a discontinuous oil phase which contains the organopolysiloxanes (a) containing polar groups, and a continuous water phase. The fractions of organopolysiloxane (a) and of the continuous water phase can be varied within wide limits, depending on the solids content desired in the emulsions and microemulsions used according to the invention. The fraction of organopolysiloxane (a) is preferably between 20 and 70 percent by weight, more preferably between 40 and 60 percent by weight of the total weight of the emulsion.

The emulsions used according to the invention preferably have an average particle size of not more than 1 μm, more preferably not more than 300 nm. The microemulsions used according to the invention preferably have an average particle size of not more than 150 nm, more preferably not more than 20 nm. The term “emulsions” also comprehends microemulsions in the text and claims herein, unless specified otherwise. The term “microemulsions” relates only to emulsions having an average particle size of not more than 150 nm, and which are transparent or optically clear. Microemulsions of organopolysiloxanes with alkylpolyglycosides as emulsifiers have not been described before.

The emulsions of the subject invention, especially the microemulsions, may also include cosurfactants, preferably in amounts of up to 30 parts by weight, more preferably not more than 20 parts by weight, in each case based on 100 parts by weight of the organopolysiloxanes (a), for example to reduce the particle size and/or to reduce the amount of alkylpolyglycosides (b) needed. The cosurfactants are polar compounds of medium molar mass, such as C₄ to C₈ alcohols, suitable glycol ethers, amines, esters or ketones. Alcohols are preferred cosurfactants.

Examples of particularly suitable cosurfactants are 1-butanol, 2-butanol, 2-methyl-2-propanol, 1-pentanol, 2-pentanol, 3-pentanol, 1-hexanol, 2-hexanol, 3-hexanol, 1-heptanol, 2-heptanol, 3-heptanol, 4-heptanol, 1-octanol, 2-octanol, 3-octanol and 4-octanol; diethylene glycol monomethyl, monoethyl and monobutyl ethers; diethylene glycol dimethyl and diethyl ethers; 1-aminobutane, 2-aminobutane, 2-amino-2-methylpropane, 1-aminopentane, 2-aminopentane, 1-aminohexane, 1-aminoheptane and 1-aminooctane; ethyl, propyl, isopropyl, butyl, isobutyl, pentyl, isopentyl and hexyl acetates; methyl, ethyl and tert-butyl propionates; methyl, ethyl, propyl and butyl butyrates; 2-butanone, 2-pentanone, 3-pentanone, 4-methyl-2-pentanone, 2-hexanone, 3-hexanone, 2-heptanone, 3-heptanone, 4-heptanone, 5-methyl-3-heptanone, 2-octanone and 3-octanone.

Examples of preferred cosurfactants are 1-alkanols of the above-recited examples with C₅- to C₈-chains, diethylene glycol monobutyl ether, diethylene glycol dimethyl ether, diethylene glycol diethyl ether, propyl, butyl and pentyl acetates and 2-pentanone. Particularly preferred cosurfactants are 1-pentanol, 1-hexanol and 1-octanol, diethylene glycol monobutyl ether, diethylene glycol dimethyl ether and butyl acetate.

In addition to organopolysiloxanes (a), alkylpolyglycosides (b), water and optionally cosurfactants, the emulsions used according to the invention may additionally include various additives. These are in particular, bacteriocides, fungicides, algicides, microbicides, fragrances, corrosion inhibitors, dyes, pigments, thickeners and fillers. The emulsions used according to the invention preferably include additives in amounts of 0 to 1 percent by weight, especially 0 to 0.2 percent by weight, in each case based on the total weight of the ready-produced emulsion.

The mixing of all components of the emulsion used according to the invention can be effected in any order using emulsifying machines, or by stirring together without exerting high shearing forces. However, it is preferable first to prepare a homogeneous mixture of organopolysiloxane (a), alkylpolyglycosides (b) and water and to stir the cosurfactants and additives, if used, into this mixture without exercising high shearing forces.

The pressure exerted on the respective components or mixtures is preferably the (atmospheric) pressure which may be elevated by the action of the mixing elements; the correspondingly prevailing temperature is preferably the (room) temperature which may be elevated through the action of the mixing elements.

The ammonium-functional organopolysiloxane (a) which is preferably included in the emulsions used according to the invention can be prepared by adding mineral acids or carboxylic acids to the corresponding amino-functional organopolysiloxanes. This addition of acid to organopolysiloxane (a) can take place before the organopolysiloxane (a) is used.

In a particularly preferred embodiment for preparing the emulsions used according to the invention by using the particularly preferred amino- and/or ammonium-functional organopolysiloxanes (a), however, the ammonium-functional radicals are generated in situ in the course of mixing organopolysiloxane (a), alkylpolyglycosides (b) and water by addition of the above-described mineral and/or carboxylic acids, especially acetic acid.

The emulsions used according to the invention can in principle be prepared in any turbulent mixer hitherto used for preparing emulsions. Examples of useful mixers are stirrers, such as leaf, bar, anchor, grid, screw, propeller, disk, impeller, turbine, planetary stirrers, single- and double-screw mixers, mixing turbines, colloid mills, ultrasonic mixers, inline mixers, pumps, and homogenizers such as high pressure, turbine and loop homogenizers.

To illustrate the surprising advantages of the present invention, various polyester (PES) styles were printed or jet dyed without a carrier at 130 degrees Celsius in the course of 30 to 45 minutes with various dyes known to be sensitive to conventional softening compositions. After dyeing, different silicone softeners were applied by the padding or exhaust process. This was followed by drying and heat-setting at 185 degrees Celsius for 60 seconds.

The samples thus obtained were subjected to a C4A Marks & Spencer washfastness test at 60 degrees Celsius together with a multifiber strip (acetate, cotton, nylon-6,6, polyester, polyacrylonitrile and wool).

The assessment criteria were the staining of the various adjacent fabrics and the hue change of the dyed fabric, both according to the gray scale (DIN 54002). Ratings were awarded on a scale from 1 to 5, where 5 denotes very good performance and 1 poor performance. The staining of acetate and nylon are evaluated in this assessment, since these substrates are most meaningful. All subsequent percentages are percent by weight. The softeners (WM) used were:

Softener 1: milky emulsion not in accordance with the subject invention containing 33% aminosilicone of amine number (AN) 0.3, viscosity 1,000 mPa.s containing the functional element Si-C₃H₆-NH-C₂H₄-NH₂, 6% of fatty alcohol ethoxylate (C₁₃ oxo alcohol with 6 to 8 EO), average particle size ca. 130 nm.

Softener 2: microemulsion not in accordance containing the subject invention 33% of aminosilicone (as for softener 1), 13% of fatty alcohol ethoxylate (C₁₃ fatty alcohol with 6 to 8 EO) and 5% of coemulsifier (butyldiglycol), average particle size ca. 30 nm.

Softener 3: macroemulsion not in accordance with the subejct invention containing 35% of aminosilicone of AN 0.15, viscosity 5,000 mPa-s, with the same functionality as in softener 1, 4% of fatty alcohol ethoxylate (C13 fatty alcohol with 10 EO), average particle size ca. 180 nm.

Softener 4: emulsion concentrate not in accordance with the subject invention, containing 40% of aminosilicone as in softener 1, 6% of fatty alcohol ethoxylate (C₁₃ fatty alcohol with 3 EO), 18% of alkylphenol ethoxylate (nonylphenol with 10 EO) and 6% of coemulsifier (butyldiglycol), average particle size ca. 25 nm for a 1:5 dilution.

Softener 5: emulsion in accordance with the subject invention, comprising 17% of aminosilicone of AN 0.6 and viscosity 1,000 mpa.s, the same functionality as in softener 1, 6% of alkylpolyglycoside containing C₈-C₁₀ alkyl groups with 1.8 sugar units average per molecule, particle size ca. 250 nm.

### EXAMPLE 1

Polyester fabric (PES filament) was uniformly printed with a print paste of the following recipe:

500 g of disperse stock +Calgon

20 g of dye: Dianix Red EFB (Dystar)

2 g of monosodium phosphate

15 g of Eganal PS (Clariant)

463 g water balance

---------------------------

1 kg

The print was fixed by thermosoling (210 degrees Celsius, 60 seconds) and then rinsed at 60° C. This was followed by reduction clearing with 5 g/L of alkali and 3 g/L of hydrosulfite, followed by a rinse at 80° C. The specimens were finished with softeners on a pad-mangle to a wet pickup of 65%. Specimens A through G were treated as follows:

A) 15 g/L of softener 1

B) 15 g/L of softener 2

C) 15 g/L of softener 4

D) 15 g/L of softener 5

E) 30 g/L of softener 5

F) Water

G) Untreated

The A to G specimens were subsequently dried and heat-set at 185 degrees Celsius for 60 seconds.

The specimens were washed together with the multifiber strip according to the above C4A method. The following abbreviations are used:

CA =Viscose; CO =Cotton; PA 6.6 =Nylon-6,6; and PES =Polyester.

The results are presented in Table 1.

TABLE 1

| | A | B | C | D | E | F | G |
|---|---|---|---|---|---|---|---|
| Hue change | 4-5 | 4-5 | 4-5 | 4-5 | 4-5 | 4-5 | 4-5 |
| CA | 2-3 | 2 | 1-2 | 3 | 3 | 3 | 3-4 |
| CO | 4-5 | 4 | 3-4 | 5 | 5 | 5 | 5 |
| Nylon-6,6 | 2-3 | 2 | 1-2 | 3 | 3 | 3 | 3-4 |
| PES | 4-5 | 4 | 3-4 | 5 | 5 | 5 | 5 |

### EXAMPLE 2

PES fabric (made of texturized yarns, not set before dyeing) was jet dyed with the following dye combinations from the Dystar Dianix range which are known to be particularly fast to setting:

Red: Dianix Yellow 4G 0.23% +Dianix Red SE 3B 0.51% +Dianix Red K2B 0.54%

Black: Dianix Orange K3G 0.12% +Dianix Red S2G 0.2% +Dianix black RXNFS 200% thereof 3.5%

The dyeing was carried out at pH 4.5 (set with acetic acid) and 130° C. for 45 minutes in the presence of 1 g/L of Dispersogen PN and 2 g/L of sodium acetate.

Reduction clearing was accomplished with 5 g/L of NaOH 38° Be and 3 g/L of sodium hydrosulfite at 80° C for 15 minutes.

The specimens were finished in Series 1 with the following liquors at pH 6.0 on a pad-mangle to wet pickup 65%:

| | |
|---|---|
| A) | 15 g/L of softener 1 |
| B) | 15 g/L of softener 2 |
| C) | 15 g/L of softener 4 |
| D) | 15 g/L of softener 5 |
| E) | 30 g/L of softener 5 |
| F) | Water |
| G) | Untreated |

Series 2 was carried out in an exhaust process at 60 degrees for 20 minutes, as follows:

| | |
|---|---|
| A) | 1.5% of softener 1 |
| B) | 1.5% of softener 2 |
| C) | 1.5% of softener 4 |
| D) | 1.5% of softener 5 |
| B) | 3.0% of softener 5 |
| F) | Water |
| G) | Untreated. |

This is followed as usual by drying and heat-setting at 185 degrees Celsius for 1 minute. M & S washing in the described manner together with DW multifiber strip gave the following values:

TABLE 2
Red Dyeing Padding/+E,uns exhaust process

| | A | B | C | D | E | F | G |
|---|---|---|---|---|---|---|---|
| CA | 2-3/+E,uns 2-3 | 2/+E,uns 2 | 1-2/+E,uns 1-2 | 3/+E,uns 3 | 3/+E,uns 3 | 3/+E,uns 3 | 3/+E,uns 3 |
| CO | 5/+E,uns 5 | 4-5/+E,uns 4-5 | 4/+E,uns 4 | 5/+E,uns 5 | 5/+E,uns 5 | 5/+E,uns 5 | 5/+E,uns 5 |
| Nylon-6,6 | 3/+E,uns 3-4 | 2-3/+E,uns 2-3 | 2/+E,uns 2 | 4/+E,uns 4 | 4/+E,uns 4 | 4/+E,uns 4 | 4/+E,uns 4 |
| PES | 4-5/+E,uns 4-5 | 4/+E,uns 4 | 3-4/+E,uns 3-4 | 5/+E,uns 5 | 5/+E,uns 5 | 5/+E,uns 5 | 5/+E,uns 5 |

TABLE 3
Black Dyeing Padding/+E,uns exhaust process

| | A | B | C | D | E | F | G |
|---|---|---|---|---|---|---|---|
| CA | 2-3/+E,uns 3 | 2/+E,uns 2 | 1-2/+E,uns 2 | 3-4/+E,uns 3-4 | 3-4/+E,uns 3-4 | 3-4/+E,uns 3-4 | 3-4/+E,uns 3-4 |
| CO | 4-5/+E,uns 4-5 | 4/+E,uns 4 | 3-4/+E,uns 3-4 | 4-5/+E,uns 4-5 | 4-5/+E,uns 4-5 | 4-5/+E,uns 4-5 | 5/+E,uns 5 |
| Nylon-6,6 | 3/+E,uns 4 | 2-3/+E,uns 3 | 2/+E,uns 2 | 4/+E,uns 4-5 | 4/+E,uns 4-5 | 4/+E,uns 4-5 | 4-5/+E,uns 4-5 |
| PES | 4-5/+E,uns 4-5 | 3-4/+E,uns 3-4 | 3/+E,uns 3 | 4-5/+E,uns 4-5 | 4-5/+E,uns 4-5 | 4-5/+E,uns 4-5 | 5/+E,uns 5 |

### EXAMPLE 3

Example 2 was repeated to dye PES fabric blue with 0.98% of Dianix Dark Blue KR +Dianix Black KB 0.31%. The specimens were padded in Series I and exhaust treated in Series II. The softeners used were:

| | |
|---|---|
| H) | 15 g/L or 1.5% of softener 1 |
| I) | 15 g/L or 1.5% of softener 2 |
| J) | 15 g/L or 1.5% of softener 3 |
| K) | 10 g/L or 1.0% ofsoftener4 |
| L) | 30 g/L or 3.0% of softener 5 |
| M) | Water |
| N) | Untreated |

Padding was carried out to a 65% wet pickup. The exhaust process was carried out at 60 degrees Celsius and pH 6 for 20 minutes. Heat-setting was carried out as usual at 185 degrees Celsius for 1 minute.

Blue Dyeing Padding/+E,uns exhaust process

| | A | B | C | D | E | F | G |
|---|---|---|---|---|---|---|---|
| CA | 3/+E,uns 3 | 2-3/+E,uns 3 | 3/+E,uns 3 | 2/+E,uns 2 | 4/+E,uns 4 | 4/+E,uns 4 | 4/+E,uns 4 |
| CO | 4/+E,uns 4 | 4/+E,uns 4 | 4/+E,uns 4 | 3-4/+E,uns 3-4 | 4-5/+E,uns 4-5 | 4-5/+E,uns 4-5 | 4-5/+E,uns 4-5 |
| Nylon-6,6 | 2-3/+E,uns 3 | 2-3/+E,uns 3 | 3/+E,uns 2-3 | 2/+E,uns 2 | 3-4/+E,uns 3-4 | 3-4/+E,uns 3-4 | 4/+E,uns 4 |
| PES | 4/+E,uns 4 | 3/+E,uns 3 | 4/+E,uns 4 | 3/+E,uns 3 | 4-5/+E,uns 4-5 | 4-5/+E,uns 4-5 | 4-5/+E,uns 4-5 |

The above experimental series demonstrate that the washfastnesses of the specimens treated with the inventive softener is virtually the same compared with water-treated fabrics. Conventional softeners, in contrast, produced deteriorations of up to 2 rating levels, and correlation was observed between the deterioration in the rating and the specific content of ethoxylated emulsifiers.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A polyester fabric comprising at least one polar organopoly-siloxane and at least one alkylpolyglycoside.

2. The polyester fabric of claim 1 which has been dyed or printed with a disperse dye.

3. The polyester fabric of claim 1, wherein said organopolysiloxane is an amino-functional polar organopolysiloxane.

4. The polyester fabric of claim 2, wherein said organopolysiloxane is an amino-functional polar organopolysiloxane.

5. The polyester fabric of claim 1, wherein the weight ratio of organopolysiloxane to said alkylpolyglycoside is in the range from 10:1 to 0.5:1.

6. The polyester fabric of claim 2, wherein the weight ratio of organopolysiloxane to said alkylpolyglycoside is in the range from 10:1 to 0 5:1.

7. The polyester fabric of claim 3, wherein the weight ratio of organopolysiloxane to said alkylpolyglycoside is in the range from 10: 1 to 0.5:1.

8. The polyester fabric of claim 4, wherein the weight ratio of organopolysiloxane to said alkylpolyglycoside is in the range from 10:1 to 0.5:1.

9. In a process for treating a polyester-containing fabric with a fabric softening composition, the improvement comprising applying a softening composition comprising at least one polar organopolysiloxane and at least one alkylpolyglycoside.

10. The process of claim 9, wherein said at least one organopolysiloxane and said at least one alkylpolyglycoside are applied in the form of an aqueous emulsion.

11. The process of claim 9, wherein said polar organopolysiloxane comprises at least one organopolysiloxane comprising units of the formula
RₙR′ₘSiO_{(4-n-m)/2} (I)
where
R are identical or different, substituted or unsubstituted C₁₋₁₈ hydrocarbyl radicals or C₁₋₁₈ hydrocarbyloxy radicals, or are hydrogen atoms or hydroxyl radicals,
R′ are identical or different Si-C-bonded hydrocarbyl radicals containing polar groups as substituent(s),
n is 0, 1, 2 or 3,
m is 0, 1, 2 or 3,
the sum (n+m) in the organopolysiloxane has an average value of 1.8 to 2.2, and m is such that the polyorganosiloxane has at least one R′ radical.

12. The process of claim 11 wherein the sum (n+m) has an average value of 1.9 to 2.1.

13. The process of claim 11, wherein at least one R′ is an amino-functional radical of the formula
—R¹-[NR²(CH₂)ₐ]_{b}NHR² (II)
or an ammonium salt thereof preparable by reaction with mineral or carboxylic acids, where
R¹ is a divalent C₁- to C₁₈-hydrocarbyl radical,
R² is a hydrogen atom or an optionally fluorine-, chlorine- or bromine-substituted C₁- to C₁₈-hydrocarbyl radical,
a is 2, 3, 4, 5 or 6 and
b is 0, 1, 2, 3 or 4.

14. The process of claim 13 wherein
R¹ is a divalent C₂- to C₆-hydrocarbyl radical,
R² is a hydrogen atom, a methyl radical, or a cyclohexyl radical,
a is 2or 3, and
b is 0 or 1.

15. The process of claim 11 wherein said polar organopolysiloxane bears at least one polar group selected from the group consisting of H₂N(CH₂)₂NH(CH₂)₃-, H₂N(CH₂)₂NHCH₂CH(CH₃)CH₂-,
H₂N(CH₂)₃-,

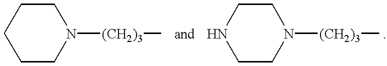

16. The process of claim 11 wherein said softening composition further comprises at least one cosurfactant in an amount of up to 30 weight percent.

17. The process of claim 16, wherein at least one cosurfactant is selected from the group consisting of C₄₋₈ alcohols, glycol ethers, amines, esters, or ketones.

18. The process of claim 17 wherein said cosurfactant comprises at least one cosurfactant selected from the group consisting of 1-pentanol, 1-hexanol, 1-octanol, diethylene glycol monobutyl ether, diethylene glycol dimethyl ether, and butyl acetate.

19. The process of claim 11 wherein said softening composition is an aqueous microemulsion having an organopolysiloxane discontinuous phase with an average particle size of 150 nm or less.
